(19) United States
(12) Patent Application Publication
(10) Pub. No.: US 2025/0024264 A1
(43) Pub. Date: Jan. 16, 2025

(54) FRAUD IDENTIFICATION AND AUTHENTICATION SYSTEM USING SECONDARY CHANNELS

(71) Applicant: T-Mobile USA, Inc., Bellevue, WA (US)

(72) Inventors: Jan Olav Opedal, Ellensburg, WA (US); Yasmin Karimli, Kirkland, WA (US)

(21) Appl. No.: 18/350,576

(22) Filed: Jul. 11, 2023

(51) Int. Cl. H04W 12/126; H04W 12/72

(52) U.S. Cl. CPC H04W 12/126; H04W 12/72

(57) ABSTRACT

Various implementations generally relate to systems and methods for receiving a request from a user to perform an action related to a customer account of an enterprise, generating an anomaly score for the action, identifying a secondary channel associated with the customer account, transmitting a message to a user device over the secondary channel, processing results of the transmitted message, predicting a likelihood the action is fraudulent, and allowing or denying execution of the action based on the predicted likelihood.

### BACKGROUND

Identity fraud is the use by one person of another person's personal information, without authorization, to commit a crime or to deceive or defraud that other person or a third person. One common type of identity fraud in cyberspace, a subscriber identity module (SIM) swap scam, also known as SIM splitting, smishing, and SIM swapping, is a type of account takeover fraud that generally targets a weakness in two-factor authentication and two-step verification in which the second factor or step is a text message (SMS) or call placed to a mobile telephone.

The fraud exploits a mobile phone service provider's ability to seamlessly port a phone number to a device containing a different SIM. This mobile number portability feature is normally used when a phone is lost or stolen or a customer is switching service to a new phone.

The scam begins with a fraudster gathering personal details about the victim, either by use of phishing emails, by buying them from organized criminals, or by directly socially engineering the victim. Armed with these details, the fraudster contacts the victim's mobile telephone provider. The fraudster uses social engineering techniques to convince the telephone company to port the victim's phone number to the fraudster's SIM. This is done, for example, by impersonating the victim using personal details to appear authentic and claiming that they have lost their phone.

### BRIEF DESCRIPTION OF THE DRAWINGS

Detailed descriptions of implementations of the present invention will be described and explained through the use of the accompanying drawings.

FIG. 1 is a block diagram that illustrates a fraud mitigation system of an enterprise in which aspects of the disclosed technology are incorporated.

FIG. 2 is a block diagram illustrating functional modules executed by the fraud mitigation system, according to some implementations.

FIG. 3 is a flowchart illustrating a process for detecting fraud upon receiving a user request to perform a SIM swap related to a customer account, according to some implementations.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technologies address problems faced by enterprises, such as mobile phone service providers, in dealing with identity fraud associated with enterprise customers. Various implementations generally relate to systems and methods for responding to a request from a user to perform an action related to a customer account using secondary channels to authenticate the request.

In some implementations, a fraud mitigation system is designed to detect fraud associated with a request for a SIM swap. An anomaly score module is configured to generate an anomaly score that represents a degree of deviation of the request from expected actions associated with a user device that requested the SIM swap. The anomaly score is then compared to a predetermined threshold, and a secondary channel selection module determines if a secondary channel is needed to authenticate the request. After the secondary channel selection module identifies the secondary channel, a message is sent to a user device through the secondary channel. Responses to the message are recorded and analyzed, and the secondary channel selection module generates a secondary channel validation score. A fraud mitigation module generates a fraud likelihood indicator based on the anomaly score and the secondary channel validation score. The fraud likelihood indicator represents a likelihood of fraud associated with the SIM swap request. If the fraud likelihood indicator is greater than a predetermined threshold, the fraud mitigation system sends a command to the user device to deny SIM swap.

Implementations described herein use one or more secondary channels to authenticate requests from a user to perform an action related to a customer account. By authenticating the requests through use of one or more secondary channels to analyze authenticity of the requests, the fraud mitigation system is able to determine whether the request is associated with fraud more accurately.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

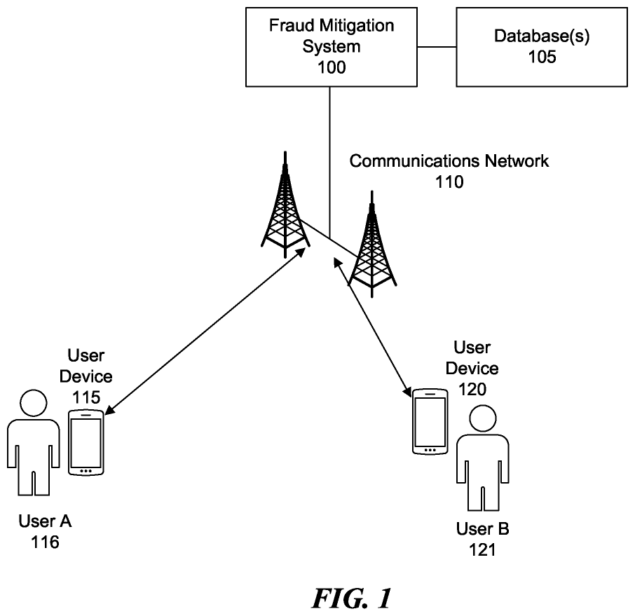

FIG. 1 is a block diagram that illustrates a fraud mitigation system 100 of an enterprise in which aspects of the disclosed technology are incorporated. As illustrated in FIG. 1, the fraud mitigation system 100 may include a communications network 110, one or more user devices 115 and 120 (such as a mobile phone, tablet computer, desktop computer, wearable computing device, etc.), and one or more databases 105.

The communications network 110 includes one or more base stations, which is a type of network access node (NAN) that can also be referred to as a cell site, a base transceiver station, or a radio base station. The communications network 110 enables the fraud mitigation system 100 to communicate with user devices 115 and 120 by transmitting and receiving data, requests, and commands. In some implementations, the communications network 110 includes multiple networks to facilitate communications between and among the multiple networks.

An example of the communications network 110 enabling the fraud mitigation system 100 to communicate with the user devices 115 and 120 is shown in FIG. 1. User A 116 is a customer of an enterprise who uses the user device 115 to perform various actions on an enterprise mobile application. The actions can include paying monthly bills, requesting to create a new account associated with the customer account, requesting to purchase a phone, or requesting SIM swap through the enterprise mobile application in the user device 115. Where the action of user A is a request for a SIM swap from the user device 115 to another device, the fraud mitigation system 100 processes the SIM swap request to generate an anomaly score associated with the request. Upon determining that the anomaly score is above a predetermined threshold, the fraud mitigation system 100 contacts a secondary channel to authenticate the SIM swap request. In some implementations, the secondary channel is a user device already existing in the communications network 110, such as the user device 120 owned by user B 121. In other implementations, the secondary channel is a contact that is saved in the one or more databases 105 and retrieved following the anomaly score exceeding the predetermined threshold. Once the fraud mitigation system 100 completes authenticating the SIM swap request through the secondary channel, the results of the authentication process are transmitted to a fraud mitigation module. The fraud mitigation module analyzes the anomaly score and the results of the secondary channel authentication process to predict a likelihood that the SIM swap request is fraudulent. Upon determining that the SIM swap request is fraudulent, the fraud mitigation system 100 sends a command to an enterprise computer system via the communications network 110 to block user A's SIM swap request.

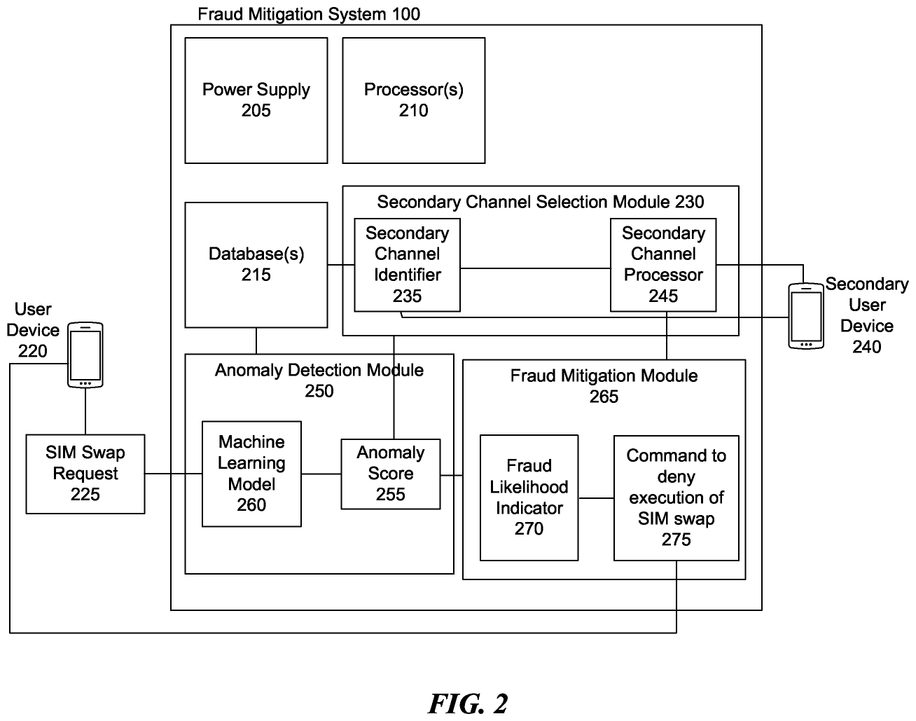

FIG. 2 is a block diagram illustrating functional modules executed by the fraud mitigation system 100 to determine if a SIM swap request is associated with fraud, according to some implementations. As shown in FIG. 2, the fraud mitigation system 100 includes a secondary channel selection module 230, an anomaly detection module 250, and a fraud mitigation module 265. Other implementations of the fraud mitigation system 100 include additional, fewer, or different modules or distribute functionality differently between the modules. As used herein, the term “module” refers broadly to software components, firmware components, and/or hardware components. Accordingly, the modules 230, 250, and 265 could each be comprised of software, firmware, and/or hardware components implemented in, or accessible to, the fraud mitigation system 100. The fraud mitigation system 100 also includes power supply 205, one or more processors 210, and one or more databases 215.

The process of determining if a SIM swap request 225 is associated with fraud begins with the fraud mitigation system 100 receiving a SIM swap request 225 from a user device 220. The user device 220 can include any computing device that includes a SIM, such as a mobile phone or a SIM-enabled tablet computer or wearable device. The SIM swap request 225 is a request to port a mobile phone number associated with the user device 220 to another device containing a different SIM. The SIM swap request 225 may be requested in person (e.g., in a store operated by a telecom provider) and involve an individual bringing in the user device 220 and another device to which the mobile phone number is being ported. For example, in response to the in-person request from the individual, a customer representative at the store operated by the telecom provider submits the SIM swap request 225 using a computer in the store, thereby signaling receipt of the SIM swap request 225 in an enterprise computer system.

The SIM swap request 225 may also be requested remotely through a phone call with a representative of the telecom provider, a telecom provider website, or a mobile application of the telecom provider on the user device 220. For example, a user of the user device 220 can make a phone call to a customer service agent of the telecom provider using the user device 220. The user makes a request for a SIM swap, which is automatically associated with the user device 220 because the user made the phone call using the user device 220.

After receiving the SIM swap request, the fraud mitigation system 100 employs the anomaly detection module 250 to analyze the SIM swap request 225 to generate an anomaly score 255 associated with the SIM swap request 225. The anomaly score 255 represents a degree of deviation of the SIM swap request 225 from expected actions associated with the user associated with the user device 220.

To generate the anomaly score 255, the anomaly detection module 250 may refer to the one or more databases 215 containing customer information to locate information related to the user making the SIM swap request 225. Relevant information can include gender, age group, socioeconomic class, noticeable purchase patterns, age of account, or a comparison of last identified location of the user device 220 and location where the SIM swap request 225 was made. Based on the information retrieved from the one or more databases 215, the anomaly detection module 250 may identify one or more risk factors and assess the risk factors associated with the SIM swap request 225. For example, based on an analysis of past transactions, the anomaly detection module 250 may identify that certain types of transactions are more likely to be fraudulent and records of the certain types of transactions associated with the user device 220 indicate a high risk of anomaly, which is subsequently reflected in the generation of a high anomaly score 255. In another example, the anomaly detection module 250 may identify that purchase patterns of a customer are risk factors that can affect the anomaly score 255. As an example, when the SIM swap request 225 is made from the user device 220 to another device, which is identified as a high-end mobile device, the anomaly detection module 250 refers to the one or more databases 215 for past purchase patterns. Upon identifying no history of purchasing high-end mobile devices, the anomaly detection module 250 determines that the SIM swap request 225 is at high risk of being associated with fraud and generates the anomaly score 255 accordingly.

In some implementations, the anomaly score 255 can be based on a rule-based model. For example, the rule applied can be the haversine formula, which determines the angular distance between two locations on Earth. The anomaly detection module 250 uses the rule to determine feasibility of location of the SIM swap request 225 based on past identified location and time elapsed between the identification and the SIM swap request 225. The anomaly detection module 250 outputs the anomaly score 255 based on the feasibility analysis.

In other implementations, the anomaly score 255 can be based on a trained machine learning model 260. The fraud mitigation system 100 uses one or more trained machine learning models throughout the fraud detection process, according to various implementations. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, a model used by the fraud mitigation system 100 can be a neural network with multiple input nodes that receive previous SIM swap requests from users as inputs. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer (the “output layer”), one or more nodes can produce a value classifying the input that, once the model is trained, can be used to detect whether an incoming SIM swap request is associated with fraud. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

One or more of the machine learning models described herein can be trained with supervised learning, where the training data includes previous SIM swap requests from users as input and a desired output, such as an anomaly score associated with each SIM swap request. Additionally, in some implementations, a representation of a given user's behavior (e.g., as a set of application use data collected over a period of time) can be provided to the model by the one or more databases 215 of the fraud mitigation system 100 to allow the model to calculate a deviation of the SIM swap request from expected activities associated with the given user. Output from the model can be compared to the desired output for that user's behavior, and based on the comparison, the model can be modified, such as by changing weights between nodes of the neural network or parameters of the functions used at each node in the neural network (e.g., applying a loss function). After applying each set of user behavior data in the training data and modifying the model in this manner, the model can be trained to evaluate subsequent SIM swap requests.

Once the anomaly detection module 250 generates the anomaly score 255 associated with the SIM swap request 225, the secondary channel selection module 230 receives the anomaly score 255 to determine if a secondary channel should be contacted for further authentication of the SIM swap request 225. A primary channel is a communication channel related to a transaction associated with the SIM swap request 225. For example, if the user is requesting the SIM swap to port a mobile phone number associated with the user device 220 to another device, the mobile phone number is the primary communication channel associated with the SIM swap request 225. A secondary channel is any communication channel other than the primary channel. In some implementations, an identifier of the secondary channel is pre-recorded in the one or more databases 215 to ensure that the user requesting the SIM swap, who may be attempting the SIM swap fraud, is not associated with the secondary channel. The secondary channel can include an alternative phone number for the user recorded in the one or more databases 215. The secondary channel can also include a phone number for an individual related to the user, such as a family member or a friend whose identity is recorded in the one or more databases 215. Alternatively or additionally, the secondary channel can include other means of communication associated with the user, such as the user's email address, social media account, or a combination of one or more of the means of communication listed above.

Upon receiving the anomaly score 255 from the anomaly detection module 250, the secondary channel selection module 230 may compare the anomaly score 255 to a predetermined threshold to determine whether an authentication process through one or more secondary channels is necessary. If the anomaly score 255 is below the predetermined threshold, the secondary channel selection module 230 may conclude that the authentication process is not required and notify the fraud mitigation system 100 accordingly. Alternatively, the anomaly score 255 below the predetermined threshold may trigger the secondary channel selection module 230 to identify secondary channels that require less security, such as an email verification or a text verification to the phone number associated with the SIM swap request 225, and proceed with the authentication process.

If the anomaly score 255 is at or above the predetermined threshold, the secondary channel selection module 230, using the secondary channel identifier 235, may retrieve relevant secondary channel selection from a data record in the one or more databases 215. Upon retrieving the secondary channel selection, the secondary channel selection module 230 may select one or more secondary channels. In some implementations, the secondary channel is preconfigured by the user (e.g., when creating an account to use the user device 220), and the secondary channel selection module 230 correspondingly retrieves an identifier of the preconfigured secondary channel. In other implementations, the secondary channel selection module 230 automatically detects relationships between people based on customer account records saved in the one or more databases 215. For example, if the customer account of the user device 220 is a joint account with another user, the secondary channel selection automatically assumes that the phone number associated with the other user is a reliable secondary channel for the authentication process.

The secondary channel selection module 230 may categorize the secondary channels into different levels of severity and select different secondary channels based on the type of transaction associated with the SIM swap request 225. For example, an in-person SIM swap request may require less security, so the secondary channel identifier 235 identifies email verification or text verification as preferred secondary channels for the authentication process. On the other hand, online SIM swap requests may require more security, so the secondary channel identifier 235 identifies secondary channels associated with higher levels of severity to proceed with the authentication process.

In some implementations, the secondary channel selection module 230 is pre-configured to select different channels based on the anomaly score 255. The anomaly score 255 within a certain range may trigger the secondary channel identifier 235 to identify multiple secondary channels. Alternatively or additionally, the anomaly score 255 within a certain range may trigger the secondary channel identifier 235 to identify verification via a phone call to a secondary user device 240 as the appropriate secondary channel.

The authentication process differs based on the secondary channel identified by the secondary channel identifier 235. In some implementations, the authentication process is a simple click on an email link or a text message. In other implementations, the authentication process involves voice fingerprinting through a phone call or a series of questions that are sent over the identified secondary channel. The series of questions, which may be saved and retrieved from the one or more databases 215, may include questions that are designed to authenticate an association between the user device 220 that initiated the SIM swap request 225 and the secondary user device 240 associated with the identified secondary channel.

A secondary channel processor 245 generates an output based on the authentication process using the secondary channel. The output can be a simple yes or no to the validity of the secondary channel that authenticates the association between the user device 220 and the secondary user device 240 associated with the secondary channel. In some implementations, the output by the secondary channel processor 245 involves a secondary channel validation score measured on a scale. A higher secondary channel validation score may correlate to a higher likelihood of the secondary channel being authentic.

After the anomaly detection module 250 and the secondary channel selection module 230 generate the anomaly score 255 and the secondary channel validation score, respectively, the fraud mitigation module 265 receives the anomaly score 255 and the secondary channel validation score. The fraud mitigation module 265 utilizes the received scores to predict a likelihood that the SIM swap request 225 is associated with fraud. The fraud mitigation module 265 may generate a fraud likelihood indicator 270. The fraud likelihood indicator 270 can be a score assessing the likelihood that the SIM swap is fraudulent, e.g., on a continuous scale from 0-1. A score of 0 may indicate no likelihood of fraud, and 1 may indicate certain fraud associated with the SIM swap request 225. In other implementations, the fraud likelihood indicator 270 can be a binary assessment of the likelihood of fraud, where the only available values are 0 and 1, indicating “not likely fraud” or “likely fraud,” respectively.

In some implementations, the fraud mitigation module 265 predicts that an action is fraudulent if the anomaly score 255 and the secondary channel validation score satisfy one or more specified criteria. For example, if the anomaly score 255 is greater than a first threshold (e.g., 85% or higher), the fraud mitigation module 265 outputs a prediction that the SIM swap request 225 is fraud. If the anomaly score 255 is below a second threshold (e.g., 20% or lower), the fraud mitigation module 265 predicts the SIM swap request 225 is not fraud. If the anomaly score 255 is between the first and second thresholds, the fraud mitigation module 265 uses the secondary channel validation score in addition to the anomaly score to predict the likelihood of fraud. For example, a lower secondary channel validation score in conjunction with a lower anomaly score may indicate that the SIM swap request 225 is likely associated with fraud, whereas a higher secondary channel validation score in conjunction with a higher anomaly score may not be a cause for concern.

In other implementations, the fraud mitigation module 265 trains a machine learning model to perform deep learning (also known as deep structured learning) directly on one or more databases 215 of the fraud mitigation system 100 to learn more information about past SIM swap requests and anomaly scores and secondary channel validation scores associated with the requests. The fraud mitigation module 265 applies the trained machine learning model to the anomaly score 255 and the secondary channel validation score to predict the likelihood that the SIM swap request 225 is associated with fraud. In some implementations, using the training data, the trained machine learning model determines that the anomaly score 255 greater than a preset threshold makes it likely that the SIM swap request 225 is fraud, independent of analysis of the secondary channel validation score. Similarly, the trained machine learning model also determines that the secondary channel validation score below a preset threshold makes it likely that the SIM swap request 225 is fraud, independent of analysis of the anomaly score 255. Alternatively, the trained machine learning model may determine that the secondary channel validation score below the preset threshold requires an authentication process through another secondary channel and communicate to the secondary channel selection module 230 accordingly.

After the fraud mitigation module 265 generates the fraud likelihood indicator 270, the fraud mitigation module 265 may compare the fraud likelihood indicator 270 to a predetermined threshold. Where the likelihood of fraud is greater than the predetermined threshold, the fraud mitigation system 100 may generate a command 275 to the enterprise computer system to deny execution of the SIM swap. In some implementations, where the SIM swap request 225 is conducted online or over the phone, the fraud mitigation module 265 generates an additional command to freeze the customer account associated with the user device 220 (e.g., to block the SIM swap and other transactions related to the customer account). The fraud mitigation system 100 may require in-person authentication to unfreeze the customer account. In other implementations, where the SIM swap request 225 is conducted in person, the fraud mitigation module 265 also generates an additional command to freeze the customer account associated with the user device 220. The fraud mitigation system 100 may require the user associated with the customer account to visit another store operated by the telecom provider to unfreeze the customer account. Unfreezing the customer account may require the user to provide additional personal data, such as biometric data or secondary identification.

When the fraud likelihood indicator 270 is below the predetermined threshold, the fraud mitigation module 265 may generate a command to allow execution of the SIM swap request 225. If, based on the analysis of the anomaly score 255 and the secondary channel validation score, the fraud mitigation module 265 determines that further review is needed, the fraud mitigation module 265 may communicate with the secondary channel selection module 230 to select an alternate secondary channel to perform additional authentication.

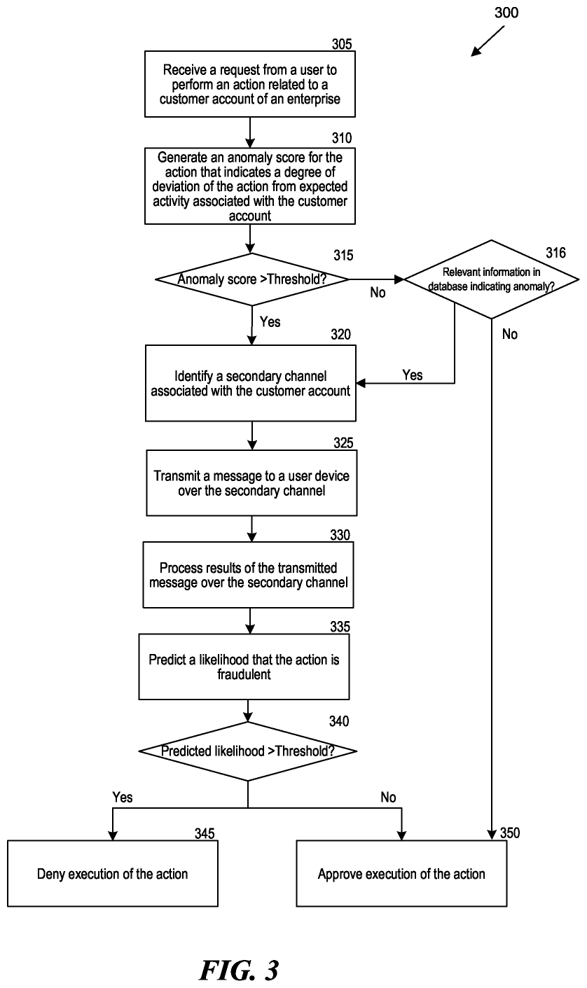

FIG. 3 is a flowchart illustrating a process 300 for detecting fraud upon receiving a user request to perform a SIM swap related to a customer account, according to some implementations. The process 300 can be performed by the fraud mitigation system 100, in some implementations. Other implementations of the process 300 include additional, fewer, or different steps or performing the steps in different orders.

In step 305, the fraud mitigation system 100 receives a request from a user to perform an action related to a customer account of an enterprise. The request can be a SIM swap request, where the user makes a request to port a mobile phone number associated with a mobile device to another mobile device containing a different SIM. The request can also be an action that requires accessing and/or processing sensitive personal data associated with the customer account, such as creating a new account or deleting an existing account, etc.

In step 310, in response to receiving the request, the fraud mitigation system, through an anomaly detection module, generates an anomaly score for the requested action. The anomaly score indicates a degree of deviation of the action from expected activity associated with the customer account. In some implementations, the anomaly detection module generates the anomaly score based on a trained machine learning model. Training data for supervised learning of the machine learning model includes previously requested actions associated with the customer account and/or similar types of actions previously requested by other users. In other implementations, the anomaly detection module generates the anomaly score based on one or more risk factors identified based on relevant information saved on one or more databases of the fraud mitigation system.

In step 315, the anomaly score generated by the anomaly detection module is compared to a predetermined threshold. In some implementations, the predetermined threshold represents a level of the anomaly score that triggers the fraud mitigation system to identify a secondary channel for an authentication process. If the anomaly score is below the predetermined threshold, the fraud mitigation system considers whether the one or more databases contain relevant information associated with the user that indicates anomaly. Relevant information that indicates anomaly can include abnormal purchase patterns, socioeconomic class of the user, or a comparison of last identified location of the user and the location of the action request. If the fraud mitigation system determines that no such relevant information exists in the one or more databases, the fraud mitigation system may approve execution of the requested action.

If, in step 320, the anomaly score is greater than the predetermined threshold, the fraud mitigation system proceeds to identify a secondary channel associated with the customer account. Alternatively, in step 316, if the one or more databases contain relevant information indicating anomaly, the fraud mitigation system similarly proceeds to identify the secondary channel. “Secondary channel” refers to any communication channel that is not the primary channel, which is the channel used to make the action request. Information regarding secondary channels associated with the customer account may be pre-recorded in the one or more databases to prevent fraud attempts.

The secondary channel identified may depend on the type of action requested and the anomaly score. For example, the fraud mitigation system may determine that a phone call requiring voice authentication would be appropriate for action requests with higher anomaly scores. In another example, the fraud mitigation system may determine that a simple click of a link via email or text is appropriate for action requests with lower anomaly scores. In some implementations, the fraud mitigation system can determine that multiple secondary channels may be appropriate based on the type of action requested.

In step 325, the fraud mitigation system transmits a message to a user device over the secondary channel to perform authentication of identity. As discussed in relation to step 320, the message may be a simple click of a link to authenticate the secondary channel. In other implementations, the message may include a series of personal questions that are pre-recorded in the one or more databases and designed to verify the relationship between the primary channel and the secondary channel.

In step 330, after the fraud mitigation system receives a response from the user device over the secondary channel, the fraud mitigation system processes results of the transmitted message. The result can be a binary assessment of authenticity of the secondary channel associated with the customer account. The result can also be a score, e.g., a secondary channel validation score, measured on a continuous scale from 0-1.

In step 335, the fraud mitigation system predicts a likelihood that the requested action is fraudulent based on the anomaly score and the processed results associated with secondary channel authentication. In step 340, the predicted likelihood is compared to a predetermined threshold. If the predicted likelihood is greater than the predetermined threshold, the fraud mitigation system proceeds to step 345 and denies execution of the action. In some implementations, the fraud mitigation system may further generate commands to freeze the customer account associated with the requested action. If the predicted likelihood is less than the predetermined threshold, the fraud mitigation system proceeds to step 350 and approves execution of the action. In some implementations, even when the predicted likelihood is less than the predetermined threshold, the fraud mitigation system may determine that additional authentication using another secondary channel is appropriate. The fraud mitigation system may return to step 320 to identify another secondary channel associated with the customer account to proceed with the authentication process.

### Computer System

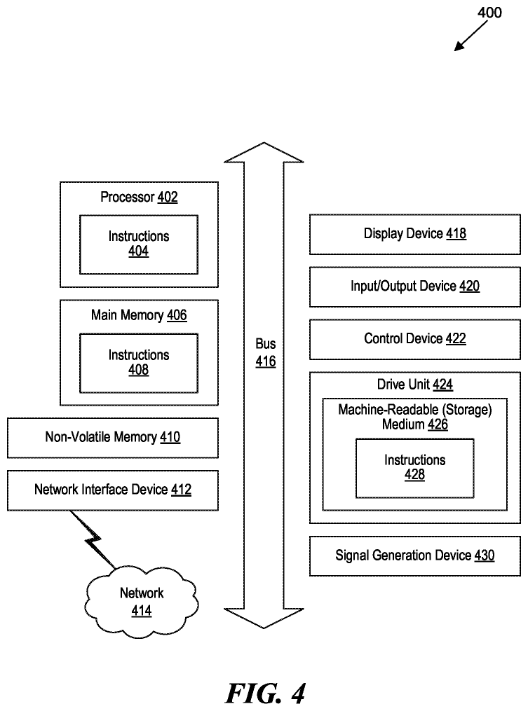

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, references to “one example” or “an example” in the disclosure can be, but are not necessarily, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the Remarks disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or they can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

1. A system comprising:
an anomaly detection module configured to:
receive a request from a user to perform a subscriber identity module (SIM) swap related to a customer account of an enterprise; and
generate an anomaly score for the requested SIM swap that indicates a degree of deviation of the SIM swap from expected activity associated with the customer account;
a secondary channel selection module configured to, when the generated anomaly score is greater than a threshold:
identify a secondary channel associated with the customer account;
transmit a message to a user device over the secondary channel; and
process results of the transmitted message over the secondary channel; and
a fraud mitigation module configured to:
based on the generated anomaly score and the processed results of the transmitted message over the secondary channel, generate a predicted a likelihood that the SIM swap is fraudulent; and
deny execution of the SIM swap when the predicted likelihood is greater than a predefined value.

2. The system of claim 1, wherein generating the anomaly score comprises:
applying a rule-based model or a trained machine learning model to detect deviation of the SIM swap.

3. The system of claim 1, wherein generating the anomaly score comprises:
detecting if a location of the request is possible based on past known location and time of travel.

4. The system of claim 1, wherein the secondary channel is pre-identified and stored in a database of the enterprise.

5. The system of claim 1, wherein the secondary channel includes an alternative phone number associated with the customer account, a phone number of an individual related to the user, an email address of the user, or a social media account of the user.

6. The system of claim 1, wherein identifying the secondary channel comprises:
retrieving, from the customer account, an identifier of a second person linked to the customer account; and
identifying a communication channel used by the second person as the secondary channel.

7. The system of claim 1, wherein identifying the secondary channel comprises:
when the anomaly score is above a first threshold, selecting a first type of secondary channel; and
when the anomaly score is above a second threshold, selecting a second type of secondary channel different than the first type of secondary channel.

8. The system of claim 1, wherein the predicted likelihood is a binary assessment of likelihood of fraud.

9. The system of claim 1, wherein processing the results of the transmitted message over the secondary channel comprises:
receiving a voice fingerprint via the secondary channel in response to the transmitted message; and
validating the voice fingerprint.

10. The system of claim 1, wherein processing the results of the transmitted message over the secondary channel comprises:
receiving a user input via the secondary channel in response to the transmitted message; and
validating the user input.

11. The system of claim 1, wherein the fraud mitigation module is further configured to:
upon denying execution of the SIM swap, freeze the customer account associated with the request.

12. The system of claim 11, wherein the request from the user is received at a first location, and wherein the fraud mitigation module is further configured to:
enable completion of the request in response to receiving verification of an identity of the user at a second location.

13. A method for fraud identification, the method comprising:
generating, by an enterprise computer system, an anomaly score for an action requested by a user,
wherein the anomaly score indicates a degree of deviation of the action from expected activity associated with a customer account of the user;
identifying, by the enterprise computer system, a secondary channel associated with the customer account based on the anomaly score;
transmitting, by the enterprise computer system, a message to a user device over the secondary channel;
processing, by the enterprise computer system, results of the transmitted message over the secondary channel;
predicting, by the enterprise computer system, a likelihood that the action is fraudulent; and
denying, by the enterprise computer system, execution of the action when the predicted likelihood that the action is fraudulent is greater than a predefined value.

14. The method of claim 13, wherein generating the anomaly score comprises:
applying a rule-based model or a trained machine learning model to detect deviation of the action.

15. The method of claim 13, wherein generating the anomaly score comprises:
detecting if a location of the request is possible based on past known location and time of travel.

16. The method of claim 13, wherein the secondary channel is pre-identified and stored in a database of the enterprise.

17. The method of claim 13, wherein the secondary channel includes an alternative phone number associated with the customer account, a phone number of an individual related to the user, an email address of the user, or a social media account of the user.

18. The method of claim 13, further comprising:
upon denying execution of the action, freezing, by the enterprise computer system, the customer account associated with the request.

19. A non-transitory, computer-readable storage medium storing executable instructions, the instructions, when executed by one or more processors, causing the one or more processors to:
receive a request from a user to perform an action related to a customer account of an enterprise;
generate an anomaly score for the action that indicates a degree of deviation of the action from expected activity associated with the customer account;
identify a secondary channel associated with the customer account based on the generated anomaly score;
transmit a message to a user device over the secondary channel;
process results of the transmitted message over the secondary channel;
based on the anomaly score and the processed results, predict a likelihood that the action is fraudulent; and
deny execution of the action when the predicted likelihood is greater than a predefined value.

20. The non-transitory, computer-readable storage medium of claim 19, wherein generating the anomaly score comprises:
detecting if a location of the request is possible based on past known location and time of travel.
